(19) United States
(12) Patent Application Publication
(10) Pub. No.: US 2004/0265547 A1
(43) Pub. Date: Dec. 30, 2004

(54) Slurry-casting products with threee-dimensional colour patterned with well-proportioned granule and colours in the mass

(76) Inventor: Dening Yang, Guangdong (CN)

Correspondence Address: FISH & RICHARDSON PC, 225 FRANKLIN ST, BOSTON, MA, 02110, US

(21) Appl. No.: 10/489,063

(22) PCT Filed: Sep. 9, 2002
(86) PCT No.: PCT/CN02/00633

(30) Foreign Application Priority Data
Sep. 10, 2001 (CN) 01127839.0

(51) Int. Cl. B32B 5/16

(52) U.S. Cl. 428/195.1; 428/323; 428/325

(57) ABSTRACT

This invention relates to a 3D patterned slip-casting product with well-proportioned colored granules in the mass, which includes ceramics for daily uses, sanitary wares and artistic wares made by suction filtration molding slip-casting or plaster mold, wherein the base includes granules having 1 or 1-50 variety of colors shaped in roundness, squareness-rhombus or oblong-rhombus with diameter of 0.2 mm-40 mm, the proportions of various granules partitions in diameter as volume percentage to the whole base, granules with minimum diameter of 0.2 mm-1.5 mm having proportion of 10%-70%, granules with minimum diameter of 1.5 mm-40 mm having proportion of 10%-95%, and the rest are the sinters of powder with diameters of 0.2 mm-0.01 mm.

### FIELD OF THE INVENTION

The present invention relates to a slip-casting product with 3D (three dimensional) patterns in the field of ceramics, and more particularly, to a 3D patterned slip-casting product with well-proportioned colored granules in the mass. Ceramic products having ceramic granite 3d patterns are produced by suction filtration molding slip-casting process, such ceramic products including articles for daily use, sanitary wares, and artistic ceramics, for example, sanitary wares such as lavatory basins, toilet bowls, and urinals, high grade ceramic articles such as table wares, tea sets, artistic ceramics such as vases and pots having novel ornamental structure

### BACKGROUND OF THE INVENTION

Existing ceramics made by suction filtration molding slip-casting roughly fall into several categories which are briefly described as follows:

The first category includes ceramics for sanitary wares and daily use with white colored bases (green ware), such as lavatory basins, toilet bowls, table wares, and tea sets, etc. with their surfaces provided with decorative glazes of solid colors, for example, red, blue, green, white, gray, cream, and so forth, lacking varieties in colors. When a solid-colored lavatory basin, for example, is installed in a stand made of marble or granite it will not gives a satisfactory decorative effect for a high-grade toilet.

The second category includes solid-colored ceramics for sanitary wares and daily use using appliqués or decals as decoration. However, Decal papers can not be applied to 3D structures on large areas, appliqués or decals can only be applied to the peripheries of the ceramic wares, for example, with some golden colored lacework designs, which ruin the aesthetic effects of a high-grade toilet with marble or granite floors and walls.

The third category includes ceramics for daily use such as tableware and tea sets using silk screen printings. Although variety kinds of patterns are available, the technology is only applicable to a plane surface, or small-sized wares, for example, the round edges of cups. Up to now silk screen printings in 3D directions on large areas are still not possible, so the range of application of silk screen printing for ceramics is very limited.

The fourth category includes a stereo ceramic granite and marble process disclosed in one of the published patents of present applicant, which including a mold with a plurality of die orifices made according to the desired patterns to be generated, and the die orifices are communicated with containers for raw materials of different colors respectively, which is the core of the process. However, the rare part of the mold for this process is so simple that when multi-color patterns with hundreds of colors are required, the containers for raw materials of different colors will become so big that there is no enough room practically available to satisfy the requirement for complicated and fine color patterns, for example, on 3D structures of sanitary wares specially.

The fifth category includes ceramics using spray decorations, which give rough patterns, especially when various colors are overlapped; surfaces of the ceramics will lose its smoothness while on the other hand less spraying easily leads to omissions of the patterns. So spraying can not be used as decoration on surfaces of large areas ceramics of various shapes therefore limiting its applicability.

The sixth category includes ceramics with striated patterns and multi-color sanitary wares with high temperature glaze and their making methods. These products have striated patterns because of their similar processing method by pouring slips of different colors into the mold via same die orifice simultaneously, so that the patterns are continuously formed from the die orifice to the enclosed area of the mold in a linear way and, i.e. patterned lines which are very thin lines at the die orifice diffuse gradually into patterned blots only when they reach the enclosed area of the mold. Because lines are continuously diffused into blots in the enclosed area, thus limiting the structural features of the products made by the above method. Although there are disclosed various methods for making ceramics with striated patterns by utilizing different pressure, velocity and time difference, they are limited by confined into the concept of pouring color slips from the die orifice of existing structure in producing slip-casting ceramics for daily use, sanitary wares and artistic wares. Therefore products produced by existing multi-color slip-casting method do not have real imitation of the patterns of natural marble and granite as desired. By and large no slip-casting ceramics of colored base for daily use, sanitary wares and artistic wares can be found in market due to lack of competitive power of such existing products. Although technical documents and product brochures describe the existing prior art as being able to produce slip-casting ceramics having various kinds of patterns that are very natural looking, these descriptions are ambiguous because it is not possible to control the patterns by prior art; therefore it is not possible to give controllable and real imitation of natural marble and granite.

The seventh category includes an product and its method disclosed in issued patent No. 98122219.6 entitled as Slip-casting Ceramics with Colored granules in the mass and Producing Method Thereof by the present applicant, in which a practicable ceramic slip-casting product and its method is provided. The product and the methods have the following defects found in application, which include undesired structure appeared when producing large volume products or products having complicated shapes because the granule size of the whole structure is defined as more than 1.5 mm. Dry granules having sizes larger than 1.5 mm to 60-80 mm are filled in the mold, when water or slips are poured into the mold, the structure become loose because too many void spaces are formed, so after water or slips are pressure poured into the mold, the granules are pressed and moved toward inside of the mold, thus leading to lack of colored granules in places where water or slips are poured, therefore defects are formed on finished product and process of producing is difficult.

It is obvious that said existing wearing plates for ball mills have drawbacks that require improvement.

### BRIEF SUMMARY OF THE INVENTION

It is an object of this invention to overcome drawbacks of existing slip-casting ceramics, and provide a 3D patterned slip-casting product with well-proportioned colored granules in the mass to present full patterns of granules like natural granite on large areas or 100% of a 3D base or a decoration surface, thus forming a ceramic granite pattern, which can be widely used in slip-casting ceramics for daily use, sanitary equipment and articles, etc, and produce 3D patterns on slip-casting products of complicated geometric configurations.

It is another object of this invention to overcome drawbacks of existing suction filtration molding slip-casting technology, and provide a 3D patterned slip-casting product with well-proportioned colored granules in the mass, to enable the surface and the inside of the base to form a structure that has an aesthetic effect exactly like a sculpture made from whole piece carved natural marble, granite or jade followed by polishing.

It is yet another object of this invention to overcome drawbacks of existing suction filtration mold slip-casting technology, and provide a 3D patterned slip-casting product with well-proportioned colored granules in the mass, to form transparent or translucent colored granules in small-sized articles for daily use such as table wares, tea sets and drinking vessels by adding bone power or bone china substitute and by other auxiliary means, and further form artwork imitating fine carved and polished article made by jade, so that producing method and structure of slip-casting ceramics can be freely controlled during its manufacture as desired.

The objects of the present invention can be achieved by providing a 3D patterned slip-casting product with well-proportioned colored granules in the mass, which includes ceramics for daily uses, sanitary wares and artistic wares made by suction filtration molding slip-casting or plaster mold, wherein the base includes 1 or 1-50 variety of colored granules which shaped in roundness, squareness-rhombus or oblong-rhombus with diameter of 0.2 mm-40 mm, with numbers of which ranging from 50 through 100 million, in which the proportions of various granules partitions in diameter as volume percent to the whole base, granules with minimum diameter (minimum diameter refers to the minimum diameter of a piece of granule in this specification of 0.2 mm-1.5 mm having proportion of 10%-70%, granules with minimum diameter of 1.5 mm-40 mm having proportion of 10%-95%, and the rest are the sinters of powder with diameters of 0.2 mm-0.01 mm.

The object of the present invention can be further achieved by providing the following technical methods.

Said 3D patterned slip-casting product with well-proportioned colored granules in the mass, wherein said base includes 2 or 2-50 variety of colored granules with minimum diameter of 1 mm-40 mm, with numbers of which ranging from 50 through 100 million.

Said 3D patterned slip-casting product with well-proportioned colored granules in the mass, wherein said product must be shaped by suction filtration mold slip-casting or plaster molding, and demolded in two or more two directions.

Said 3D patterned slip-casting product with well-proportioned colored granules in the mass, wherein surface of said base has same smooth and bright surface structure as that of the decoration facing of a product made by slip-casting or plaster molding.

Said 3D patterned slip-casting product with well-proportioned colored granules in the mass, wherein said base surface has a layer of transparent glaze.

Said 3D patterned slip-casting product with well-proportioned colored granules in the mass, wherein a colored pattern structure comprising 1 through 10000 pieces or 1 through 3 kinds of patterns by permeating are formed underneath said layer of transparent glaze.

Said 3D patterned slip-casting product with well-proportioned colored granules in the mass, wherein a layer of colored glaze pattern by spraying or stamping comprising 1 through 10000 pieces or 1 through 10 variety of colors underneath said layer of transparent glaze.

Said 3D patterned slip-casting product with well-proportioned colored granules in the mass, wherein said base also has colorless transparent vitreous granules or translucent vitreous granules or vitreous granules with high refraction index.

Said 3D patterned slip-casting product with well-proportioned colored granules in the mass, wherein said base has bone powder or other bones powder substitutes that can make the whole base present a jade like translucent property.

Said 3D patterned slip-casting product with well-proportioned colored granules in the mass, wherein said granules inside said base comprising combination of 2 through 100 variety of colored granules including red, yellow, blue, white, black, green, gray, purple, and orange, etc. or combination of granules of same color but of different shades.

From the above description one can know that compared with prior art, the present invention does not possess drawbacks and defects of existing slip-casting products and has a more stabled structure with great variety. Advantages of the present invention are further described as follows:

1. The objects of the present invention can be achieved by providing a 3D patterned slip-casting product with well-proportioned colored granules in the mass, wherein the base includes 1 or 1-50 variety of colored granules which shaped in roundness, squareness-rhombus or oblong-rhombus with diameter of 0.2 mm-40 mm, with numbers of which ranging from 50 through 100 million, in which the proportions of various colored granules are partitioned by volume percent that minimum diameter of 0.2 mm-1.5 mm with proportions of 10%-70% in the whole base, and 1.5 mm-40 mm with proportions of 10%-95% in the whole base, and the rest are the sinters of powder with diameters of 0.2 mm-0.01 mm.

Thank to the above structure, imperfectness and difficulty encountered during producing existing ceramics of large sizes or having complicated geometric structures are overcome by limiting the minimum sizes of the granules to 1.5 mm-40 mm and removing large size granules of 40 mm-80 mm to eliminate gaps formed between large size granules after dry granules are added, and also small-sized granules of 0.2 mm-1.5 mm and power materials of 0.2 mm-0.01 mm are provided to satisfyingly fill the gaps between large-sized granules when they are added into the mold so as to improve operability and rate of finished products□ and to achieve a uniform distribution of sizes of granules on the surface and in the products so as to have a better imitation of the natural granite.

2. The present invention provides full patterns of granules like natural granite on large areas or 100% of a 3D base or a decoration surface, thus forming a ceramic granite pattern, which can be widely used in slip-casting ceramics for daily use, sanitary equipment and articles, etc, and produce 3D patterns on slip-casting products of complicated geometric configurations.

3. The present invention provides a novel producing process enable the surface and the inside of the base to form a structure that has an aesthetic effect exactly like a sculpture made from whole piece carved natural marble, granite or jade followed by complicate multi-dimensional polishing.

4. The present invention provides transparent or translucent colored granules in small-sized articles for daily use such as table wares, tea sets and drinking vessels by adding bone power or bone china substitute and by other auxiliary means, and further forms artwork imitating fine carved and polished article made by jade, so that producing method and structure of slip-casting ceramics can be freely controlled during its manufacture as desired.

5. The present invention provides ceramics for daily uses, sanitary wares, and artistic wares that have an aesthetic effect exactly like a sculpture made from whole piece carved natural marble, granite or jade followed by complicate multi-dimensional polishing.

6. The present invention provides products installed in toilet stands (vanity) made of marble and granite of same patterns to form a whole part therefore gives an exquisite look. The present invention also provides toilet bowls, for example, that have same beautiful look just like stereo sculptures made by whole piece natural granite after multidimensional facets polishing. When such a toilet bowl is installed in a toilet having walls and floor decorated with natural granite or marble of the same patterns, the whole toilet room will gives an exquisite and knobby look. In addition, the present invention provides table wares and tea sets, for example, bowls, basins, cups, dishes etc., that have same decorative effects just like artistic wares made by sculpturing and polishing natural stones including jade, thereby increasing the added values to the products.

Detailed description of present invention with reference to exemplary embodiments and drawings is given hereunder.

### BRIEF DESCRIPTION OF THE DRAWINGS

FIG. 1 is a diagrammatic view of the lavatory basin of the 3D patterned slip-casting product with well-proportioned colored granules in the mass according to the present invention.

FIG. 2 is a front section view of the lavatory basin of the 3D patterned slip-casting product with well-proportioned colored granules in the mass according to the present invention.

FIG. 3 is a side section view of the lavatory basin of the 3D patterned slip-casting product with well-proportioned colored granules in the mass according to the present invention.

### DETAILED DESCRIPTION OF THE PREFERRED EMBODIMENTS

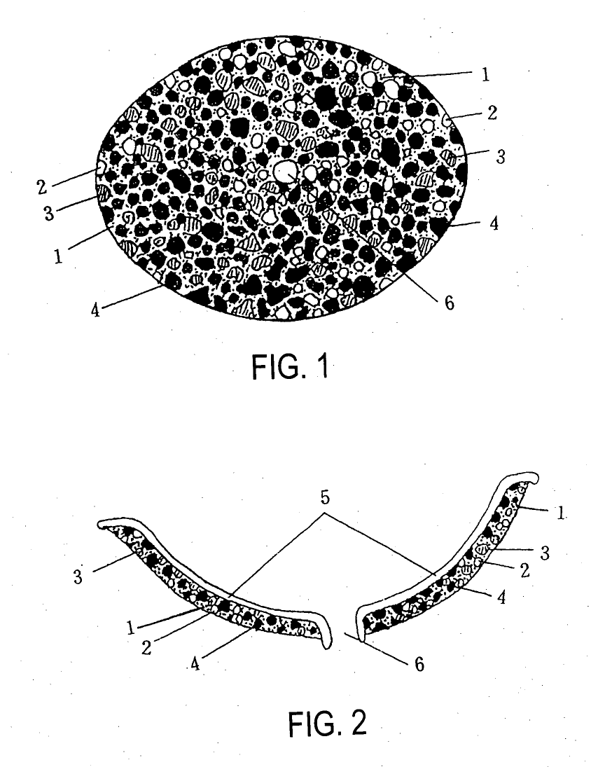

Refer to FIG. 1, in which, the black dots denote a base section 1 by firing a light red color powder material; round circles denote a gray granules portion 2 with diameter of 0.3 mm-1.5 mm; round circles with oblique lines denote a red brown granules portion 3 with diameter of 8 mm-40 mm; black ellipses denote a claret granules portion with diameter of 1.5 mm-10 mm; round hole in the middle denotes an outlet 6 of the wash basin.

Refer to FIG. 2, in which, the black dots denote a base section 1 by firing a light red color powder material; round circles denote a gray granules portion 2 with diameter of 0.3 mm-1.5 mm; round circles with oblique lines denote a red brown granules portion 3 with diameter of 8 mm-40 mm; black ellipses denote a claret granules portion with diameter of 1.5 mm-10 mm; the long and narrow section in white denote clear glaze layer 5; round hole in the middle denotes an outlet 6 of the wash basin.

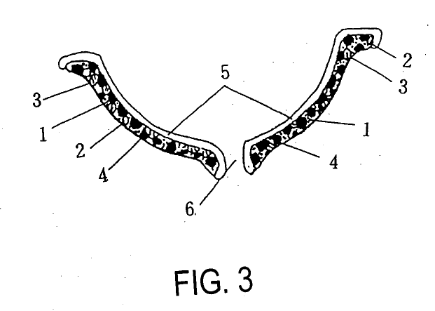

Refer to FIG. 3, in which, the black dots denote a base section 1 by firing a light red color powder material; round circles denote a gray granules portion 2 with diameter of 0.3 mm-1.5 mm; round circles with oblique lines denote a red brown granules portion 3 with diameter of 8 mm-40 mm; black ellipses denote a claret granules portion with diameter of 1.5 mm-10 mm; the long and narrow section in white denote clear glaze layer 5; round hole in the middle denotes an outlet 6 of the wash basin.

Please refer to FIG. 1, FIG. 2 and FIG. 3, a 3D patterned slip-casting product with well-proportioned colored granules in the mass according to the present invention, which includes ceramics for daily uses, sanitary wares and artistic wares made by suction filtration molding pressure slip-casting or plaster mold, wherein the base includes granules having 1 or 1-50 variety of colors shaped in roundness, squareness-rhombus or oblong-rhombus with diameter of 0.2 mm-40 mm with number of which ranging from 50 to 100,000,000 pieces, the proportions of various granules partitions in diameter as volume percentage to the whole base, granules with minimum diameter of 0.2 mm-1.5 mm having proportion of 10%-70%, granules with minimum diameter of 1.5 mm-40 mm having proportion of 10%-95%, and the rest are the sinters of powder with diameters of 0.2 mm-0.01 mm.

Said 3D patterned slip-casting product with well-proportioned colored granules in the mass according to the present invention, wherein said base includes granules having 2 or 2-50 variety of colors with minimum diameter of 1 mm-40 mm, the numbers of which ranging from 50 through 100 million.

Said 3D patterned slip-casting product with well-proportioned colored granules in the mass according to the present invention, wherein said product is shaped by using suction filtration mold pressure slip-casting or plaster molding, and is demolded in tow or more than two directions.

Said 3D patterned slip-casting product with well-proportioned colored granules in the mass according to the present invention, wherein said base has a surface that is as smooth as a decorative facing of a product produced by slip-casting of plaster molding.

Said 3D patterned slip-casting product with well-proportioned colored granules in the mass according to the present invention, wherein said base is provided with a layer of transparent glaze on the surface of said base.

Said 3D patterned slip-casting product with well-proportioned colored granules in the mass according to the present invention, wherein a colored pattern structure comprising 1-10000 pieces or 1 or 1-3 variety of color patterns by permeating are formed underneath said layer of transparent glaze.

Said 3D patterned slip-casting product with well-proportioned colored granules in the mass according to the present invention, wherein a colored glaze pattern structure comprising 1-10000 pieces or 1 or 1-10 variety of color patterns by spraying or stamping are formed underneath said layer of transparent glaze.

Said 3D patterned slip-casting product with well-proportioned colored granules in the mass according to the present invention, wherein said base is also provided therein with colorless or colored transparent vitreous granules or translucent vitreous granules or vitreous granules with high refraction index.

Said 3D patterned slip-casting product with well-proportioned colored granules in the mass according to the present invention, wherein said base is also provided with bone powder or other bone powder substitutes that can make the whole base present a jade like translucent property.

Said 3D patterned slip-casting product with well-proportioned colored granules in the mass according to the present invention, wherein the granules provided within said base comprise combination of 2-100 variety of colored granules and the colors of which can be any of the following□ red, yellow, blue, white, black, green, gray, purple, brown, or orange, etc., or combination of granules of same color but of different shades.

Now the method and the steps for making said 3D patterned slip-casting product with well-proportioned colored granules in the mass according to the present invention will be described as follows.

The method of the present invention includes three phases: making of colorized granules; shaping of the base of the product; and glazing and firing, in which:

Phase 1: making of colorized granules

Step 1, mix the ceramic materials and pigments suitable for slip-casting to form raw materials of several kinds. Then make raw slip materials with color of light red, gray, red brown, and claret, by grinding, mixing, and deferrizing the mixed raw material.

Step 2, the above raw slip materials are than processed to four kinds of power materials with four different colors by the spraying fine power forming process used in making vitrified tile.

Step 3, press the gray, brown red, and claret power materials with diameter of 0.6 mm-0.01 mm formed by the above spraying process into adobe bricks respectively with high strength under the pressure of 350-500 bar by 3000T pressing machine.

Step 4, Crash the above adobe bricks by crushing machine, and then keep the gray granules with minimum diameter of 0.2 mm-1.5 mm□ the claret granules with minimum diameter of 1.5 mm-10 mm, and the red brown granules with minimum diameter of 8 mm-40 mm.

Step 5, prepare 40% large size red brown granules with minimum diameter of 8 mm-40 mm, 20′ large size claret granules with minimum diameter of 1.5 mm-10 mm, 20% large size gray granules with minimum diameter of 8 mm-40 mm;

Step 6, prepare slip of water soluble binding agent and wrap the above mentioned 3 kinds of granules with it followed by drying so that surfaces of the granules are attached with water soluble binding agent. Finally, mix the 3 kinds of granules with 20% of the light red granules with diameter of 0.6 mm-0.01 mm.

Phase 2: Shaping of the base of the product

Step 1, The shaping of the base refers to the casting of the base with pressure. Sufficiently mix the above proportionally mixed granules and powders, and press the mixture into the plastic suction filtration mold of the lavatory basin by rotary axis pressure casting. After the mold is filled, increase the pressure and keep the pressure maintained.

Step 2, gradually pour the slip containing light red powder of low concentration into the granules inside the mold frame so that the small gaps between the granules are filled with the slip. Because granules with larger sizes have higher density with granules of varies colors well proportioned, after the slip is pressure cast into the mold, granules of various colors are immersed with water gradually so that the water soluble binding agent can only dissolve gradually to form a slurry with granules.

Step 3, start the vacuum suction filtration system immediately to draw out water and partial binding agent dissolved in the water through the microporous plastic mold wall, and then demold with the pressure maintained.

A dry base having tightly bound granules of various colors and high strength and smooth decorative surface is thus acquired.

Step 4, the base is then applied with transparent glaze after trimming, boring, scratching and drying.

Phase 4: Glazing and firing

The final product is acquired after the glazing and firing phase. The product of this embodiment presents same pattern structure and effect as that natural Paradiso granite. The combination of sintered claret, red brown, gray granules and light red powder just like the granule patterns of natural granite. Surface smoothness and fineness exactly like sculptured and fine polished natural Paradiso granite (a purple-brown granite).

In the process of this embodiment according to the present invention, in order to speed up the production rate and control the consistency and proportionality of the pressure cast granules, an apparatus with single or a plurality of mold pack can be provided. Each mold pack can use single axle, double axle or multi-axle pressure casting process to improve efficiency and controllability □ especially for products having complicated shapes.

In the embodiment according to the present invention, a secondary firing process can be used to work in with applying permeating or color glaze and transparent glaze.

It can be easily understand by technical personnel of the art that the present invention can further form granule like colored pattern by different color of silicate base, for example, red, yellow, white, blue, black, green, orange, purple etc. In addition, permeating patterns can be formed by light gray, light brown, and yellow, etc.

It can be easily understand by technical personnel of the art that silicate base masses of various colors, for example, red, yellow, white, blue, black, green, orange, and purple, etc, can be achieved by using or adding Fe₂O₃, Na₂O, V₂O₅, CoO, MnO₂, Cr₂O₃, CuO, and composition (Fe₂O₃, CoO, MnO₂, Cr₂O₃), etc., to form permeating patterns of light gray, light brown, and blue, etc. It can also be achieved by using water soluble materials, for example, cobaltous sulfate, chromium chloride, ferricchloride, manganese sulfate, sodium citrate, etc. In the above embodiments, colored silicate masses are not water soluble, while permeating materials are water soluble before firing.

The above described are only the preferred embodiments of the present invention which does not in any way limit the present invention. It should be appreciated that any modifications or changes may be made according to the preferred embodiments of the present invention without departing from the scope of technical solutions described herein.

### INDUSTRIAL APPLICABILITY

The present invention provides a novel structure suitable for mass production with relative lowered costs and more practicable for industrial use.

1. A 3D patterned slip-casting product with well-proportioned colored granules in the mass, which includes ceramics for daily uses, sanitary wares and artistic wares made by suction filtration molding slip-casting or plaster mold, wherein the base includes granules having 1 or 1-50 variety of colors shaped in roundness, squareness-rhombus or oblong-rhombus with diameter of 0.2 mm-40 mm, the numbers of which ranging from 50 through 100 million, which is characterized in that:
the proportions of various granules partitions in diameter as volume percentage to the whole base, granules with minimum diameter of 0.2 mm-1.5 mm having proportion of 10%-70%, granules with minimum diameter of 1.5 mm-40 mm having proportion of 10%-95%, and the rest are the sinters of powder with diameters of 0.2 mm-0.01 mm.

2. The 3D patterned slip-casting product with well-proportioned colored granules in the mass according to claim 1, wherein said base includes granules having 2 or 2-50 variety of colors with minimum diameter of 1 mm-40 mm, the numbers of which ranging from 50 through 100 million.

3. The 3D patterned slip-casting product with well-proportioned colored granules in the mass according to claim 1, wherein said product is shaped by using suction filtration mold pressure slip-casting or plaster molding, and is demolded in tow or more than two directions.

4. The 3D patterned slip-casting product with well-proportioned colored granules in the mass according to claim 1, wherein said base has a surface that is as smooth as a decorative facing of a product produced by slip-casting of plaster molding.

5. The 3D patterned slip-casting product with well-proportioned colored granules in the mass according to claim 1, wherein said base is provided with a layer of transparent glaze on the surface of said base.

6. The 3D patterned slip-casting product with well-proportioned colored granules in the mass according to claim 1, wherein a colored pattern structure comprising 1-10000 pieces or 1 or 1-3 variety of color patterns by permeating are formed underneath said layer of transparent glaze.

7. The 3D patterned slip-casting product with well-proportioned colored granules in the mass according to claim 1, wherein a colored glaze pattern structure comprising 1-10000 pieces or 1 or 1-10 variety of color patterns by spraying or stamping are formed underneath said layer of transparent glaze.

8. The 3D patterned slip-casting product with well-proportioned colored granules in the mass according to claim 1, wherein said base is also provided therein with colorless or colored transparent vitreous granules or translucent vitreous granules or vitreous granules with high refraction index.

9. The 3D patterned slip-casting product with well-proportioned colored granules in the mass according to claim 1, wherein said base is also provided with bone powder or other bone powder substitutes that can make the whole base present a jade like translucent property.

10. The 3D patterned slip-casting product with well-proportioned colored granules in the mass according to claim 1, wherein the granules provided within said base comprise combination of 2-100 variety of colored granules and the colors of which can be any of the following: red, yellow, blue, white, black, green, gray, purple, brown, or orange, etc., or combination of granules of same color but of different shades.

11. The 3D patterned slip-casting product with well-proportioned colored granules in the mass according to claim 2, wherein said base is also provided therein with colorless or colored transparent vitreous granules or translucent vitreous granules or vitreous granules with high refraction index.

12. The 3D patterned slip-casting product with well-proportioned colored granules in the mass according to claim 3, wherein said base is also provided therein with colorless or colored transparent vitreous granules or translucent vitreous granules or vitreous granules with high refraction index.

13. The 3D patterned slip-casting product with well-proportioned colored granules in the mass according to claim 4, wherein said base is also provided therein with colorless or colored transparent vitreous granules or translucent vitreous granules or vitreous granules with high refraction index.

14. The 3D patterned slip-casting product with well-proportioned colored granules in the mass according to claim 5, wherein said base is also provided therein with colorless or colored transparent vitreous granules or translucent vitreous granules or vitreous granules with high refraction index.

15. The 3D patterned slip-casting product with well-proportioned colored granules in the mass according claim 2, wherein said base is also provided with bone powder or other bone powder substitutes that can make the whole base present a jade like translucent property.

16. The 3D patterned slip-casting product with well-proportioned colored granules in the mass according claim 3, wherein said base is also provided with bone powder or other bone powder substitutes that can make the whole base present a jade like translucent property.

17. The 3D patterned slip-casting product with well-proportioned colored granules in the mass according claim 4, wherein said base is also provided with bone powder or other bone powder substitutes that can make the whole base present a jade like translucent property.

18. The 3D patterned slip-casting product with well-proportioned colored granules in the mass according claim 5, wherein said base is also provided with bone powder or other bone powder substitutes that can make the whole base present a jade like translucent property.

19. The 3D patterned slip-casting product with well-proportioned colored granules in the mass according to claim 2, wherein the granules provided within said base comprise combination of 2-100 variety of colored granules and the colors of which can be any of the following: red, yellow, blue, white, black, green, gray, purple, brown, or orange, etc., or combination of granules of same color but of different shades.

20. The 3D patterned slip-casting product with well-proportioned colored granules in the mass according to claim 3, wherein the granules provided within said base comprise combination of 2-100 variety of colored granules and the colors of which can be any of the following: red, yellow, blue, white, black, green, gray, purple, brown, or orange, etc., or combination of granules of same color but of different shades.

21. The 3D patterned slip-casting product with well-proportioned colored granules in the mass according to claim 4, wherein the granules provided within said base comprise combination of 2-100 variety of colored granules and the colors of which can be any of the following: red, yellow, blue, white, black, green, gray, purple, brown, or orange, etc., or combination of granules of same color but of different shades.

22. The 3D patterned slip-casting product with well-proportioned colored granules in the mass according to claim 5, wherein the granules provided within said base comprise combination of 2-100 variety of colored granules and the colors of which can be any of the following: red, yellow, blue, white, black, green, gray, purple, brown, or orange, etc., or combination of granules of same color but of different shades.
